(19) United States
(12) Patent Application Publication
(10) Pub. No.: US 2006/0013594 A1
(43) Pub. Date: Jan. 19, 2006

(54) Apparatus and method for synchronizing optic repeater in communication system using time division OFDM scheme

(75) Inventors: Sang-Hoon Sung, Suwon-si (KR); Joong-Ho Jeong, Seoul (KR); Soon-Young Yoon, Seoul (KR); Jae-Hee Cho, Seoul (KR); Hoon Huh, Seongnam-si (KR); In-Seok Hwang, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/183,542

(22) Filed: Jul. 12, 2005

(30) Foreign Application Priority Data
Jul. 12, 2004 (KR) 54112/2004

(51) Int. Cl. H04B 10/00

(52) U.S. Cl. 398/161

(57) ABSTRACT

Disclosed is a method for synchronizing of a first signal and a second signal in a communication system including a mobile station, an base station and an optic repeater, the base station and the optic repeater being connected via an optical cable. The first signal is transmitted between the base station and the mobile station, and the second signal is transmitted between the base station and the optic repeater The method includes transmitting the first signal after delaying the first signal by a predetermined fixed delay time when it is necessary to transmit the first signal; and synchronizing the second signal with the first signal by delaying the second signal by an adaptive delay time determined according to a predetermined scheme.

### PRIORITY

This application claims priority to an application entitled “APPARATUS AND METHOD FOR SYNCHRONIZING OPTIC REPEATER IN COMMUNICATION SYSTEM USING TIME DIVISION OFDM SCHEME” filed in the Korean Industrial Property Office on Jul. 12, 2004 and assigned Serial No. 2004-54112, the contents of which are incorporated herein by reference.

### BACKGROUND OF THE INVENTION

1. Field of the Invention

The present invention relates to a communication system using a time division Orthogonal Frequency Division Multiplexing (OFDM) scheme, more particularly to an apparatus and a method for synchronization of an optic repeater in the communication system.

2. Description of the Related Art

Generally, a Metropolitan Area Network (MAN) system, which is a Broadband Wireless Access (BWA) communication system, has a wider service area and supports a higher transmission speed than a Local Area Network (LAN) system. The Institute of Electrical and Electronic Engineers (IEEE) 802.16a, the IEEE 802.16d and the IEEE 802.16e communication systems employ an Orthogonal Frequency Division Multiplexing (OFDM) scheme and an Orthogonal Frequency Division Multiple Access (OFDMA) scheme in order to support a broadband transmission network for a physical channel of the wireless MAN system. In other words, the IEEE 802.16a/d/e communication system is a BWA communication system employing the OFDM/OFDMA scheme.

The IEEE 802.16a/d/e communication systems is a cellular communication system having a multiple-cell structure in which service areas for Mobile Stations (MSs) are divided into a plurality of cells. Each of the cells is controlled by its corresponding Base Station (BS). Transmitting and receiving signals between the BS and the MSs are generally performed by using the OFDM/OFDMA schemes.

The OFDM scheme has been developed as a scheme for accommodating higher speed data transmission through both wire and wireless channels. The OFDM scheme, which uses multi-carriers to transmit the data, is a special type of multi-carrier modulation (MCM) scheme in which a serial symbol sequence is converted into parallel symbol sequences where the parallel symbol sequences are modulated with a plurality of mutually orthogonal subcarriers (or subcarrier channels) before being transmitted.

The OFDM scheme groups the effective subcarriers into a plurality of subcarrier groups, that is, sub-channels. In this case, the sub-channel corresponds to a channel including at least one subcarrier which either may be or may not be adjacent to each other. As mentioned above, in the communication system using the OFDM scheme, the data is transmitted while maintaining the orthogonality between multiple subcarriers. Therefore, the communication system using the OFDM scheme can efficiently transmit high speed data and can simultaneously provide services to a plurality of users.

Cellular communication systems allow an optic repeater to be established inexpensively even in an electric wave shade area where the BS cannot be established. Consequently, the cell coverage area can be effectively extended. In this regard, a description about the relationship between the optic repeater and a typical cellular communication system will be made hereinafter with reference to FIG. 1.

FIG. 1 illustrates a schematic structure of a cell having an optic repeater in the cellular communication system.

Referring to FIG. 1, the cellular communication system having the optic repeater 152 includes two cells, that is, a cell 100 whose cell coverage is controlled by an BS 102 and a cell 150 whose cell coverage is controlled by the optic repeater 152. The BS 102 and the optic repeater 152 are connected with each other through an optical cable 130. The BS 102 converts digital signals into optical signals and then transmits the optical signals to the optic repeater 152 via the optical cable 130. Then, the optic repeater 152 converts the received optical signals into signals of corresponding radio frequencies and then transmits the signals of the radio frequencies to an MS 160 via an antenna. Therefore, even though the MS 160 is in a electric wave shade area which cannot be covered by the BS 102, the MS 160 can communicate with the BS 102 by the radio relay of the optic repeater 152

In this case, with respect to the same signal, it is possible to produce a difference between transmission instances of the BS 102 and the optic repeater 152. Specifically, the time instance when the optic repeater 152 transmits a signal to the MS 160 may become later than the time point when the BS 102 transmits the signal because there is a time delay for the signal from the BS 102 to pass through the optical cable 130 before reaching the optic repeater 152. Accordingly, it is highly possible for the MS 160 to receive a signal transmitted over the air directly from the BS 102 earlier than the signal transmitted through the optical cable 130. Factors determining such a time delay include the length of the optical cable used for cellular communication system, the transmission speed of the optical cable, and the signal processing rate of the optic repeater. Therefore, the MS 160 may receive the same signal through different paths at different time points, which can cause the following problems:

1. An inequality between frequency channel responses due to the reception of the signal through the multi-paths;

2. An inter-symbol interference (ISI) between OFDM symbols or between OFDMA symbols due to the time difference between the first and the final channel paths;

3. An inter-subcarrier interference (ICI) between subcarriers in OFDM or OFDMA symbols due to the asynchronization; and

4. Overlapping between the downlink time interval and the uplink time interval in a time division duplex communication system.

As mentioned above, in the conventional time division OFDM and OFDMA systems using the optic repeater, there are problems in that received signal quality may be deteriorated or even an interruption of communication may occur in the MS due to the asynchronism. Further, in the conventional system, the length of the optical cable should be restricted in order to minimize the time delay caused by the optical cable.

### SUMMARY OF THE INVENTION

Accordingly, the present invention has been made to solve the above-mentioned problems occurring in the prior art, and an object of the present invention is to provide an apparatus and a method for time synchronization between signals transmitted from a base station and an optic repeater in a communication system using a time division OFDM scheme.

In order to accomplish this object, one aspect of the present invention is to provide a method for synchronization of a first signal and a second signal by a base station in a downlink communication system including a mobile station, the base station and an optic repeater, the base station and the optic repeater being connected through an optical cable, the first signal being transmitted from the base station modem to the base station antenna, the second signal being transmitted from the base station modem to the optic repeater antenna, the method including transmitting the first signal after delaying or advancing the original signal by a predetermined fixed delay or advance time when it is necessary to do so; and synchronizing the second signal with the first signal by delaying or advancing the original signal by a variable delay time or a variable advance time according to a predetermined scheme.

Another aspect of the present invention is to provide a base station apparatus for synchronization of a first signal and a second signal in an uplink communication system including a mobile station, a base station and an optic repeater, the base station and the optic repeater being connected through an optical cable, the first signal being transmitted to the base station from the mobile station via air, the second signal being transmitted to the base station from the mobile station via the optic repeater, the base station apparatus including a delay controller to synchronize the first signal, which is delayed by a predetermined fixed delay, with the second signal which also is delayed by a variable delay time that is determined according to a predetermined scheme.

The other aspect of the present invention is to provide a method for synchronizing a first signal and a second signal by a base station in a communication system including a mobile station, the base station and an optic repeater, the base station and the optic repeater being connected through an optical cable, the first signal being transmitted between the base station and the mobile station, the second signal being transmitted between the base station and the mobile station via the optic repeater. The method includes transmitting the first signal after delaying the first signal by a predetermined delay time and synchronizing the second signal with the first signal by delaying the second signal by an adaptive time delay determined according to a predetermined scheme.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a schematic structure of a typical cellular communication system having an optic repeater disposed therein;

FIG. 2 illustrates a schematic structure for explaining a time synchronous control of a signal transmitted between a BS and an optic repeater according to one embodiment of the present invention;

FIG. 3 illustrates a block diagram of the structure of a BS providing time synchronization of an optic repeater in a TDD-OFDM communication system according to one embodiment of the present invention;

FIG. 4 illustrates a detailed block diagram of the structure of an optic repeater delay controller according to one embodiment of the present invention;

FIG. 5 illustrates a detailed block diagram of the structure of a timing estimator according to one embodiment of the present invention; and

FIGS. 6A and 6B are flow charts explaining an operation process of a BS synchronous control apparatus for synchronizing an optic repeater in a TDD-OFDM system according to one embodiment of the present invention.

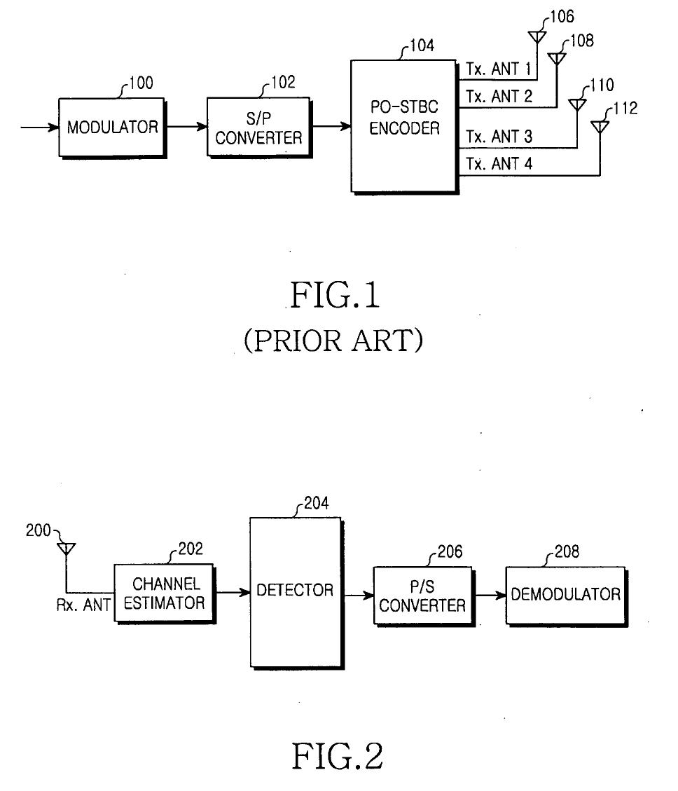

### DETAILED DESCRIPTION OF THE PREFERRED EMBODIMENT

Hereinafter, preferred embodiments of the present invention will be described with reference to the accompanying drawings. In the following description and drawings, the same reference numerals are used to designate the same or similar components, and a detailed description of known functions and configurations incorporated herein will be omitted when it may make the subject matter of the present invention unclear.

The present invention proposes an apparatus and a method for timely synchronizing transmission signals transmitted from both a BS and an optic repeater in a communication system which uses a Time Division Duplex Orthogonal Frequency Division Multiplexing (hereinafter, referring to as “TDD-OFDM”) scheme or a Time Division Duplex Orthogonal Frequency Division Multiple Access (hereinafter, referring to as “TDD-OFDMA”) scheme or an optic repeater. According to the present invention, the BS transmits a signal over the air with a fixed value for the maximum delay time corresponding to an expected maximum length of the optical cable of the optic repeater and a signal with a variable delay time to the optic repeater, thereby synchronizing the signals transmitted from the BS and the optic repeater.

Referring to FIG. 2, the BS 200 transmits signals to an MS 270 after delaying the signals for a maximum delay time (for example, 40 μs) through a fixed-time delay unit 202. Also, the BS 200 transmits signals to the optic repeater 250 after delaying the signals for a variable delay time through a variable-time delay unit 204. The maximum delay time is determined in advance based on factors such as a signal processing capability of the BS, a channel characteristic and an optical cable length. Also, it is preferred that the BS 200 includes the fixed-time delay unit 202 and the variable-time delay unit 204.

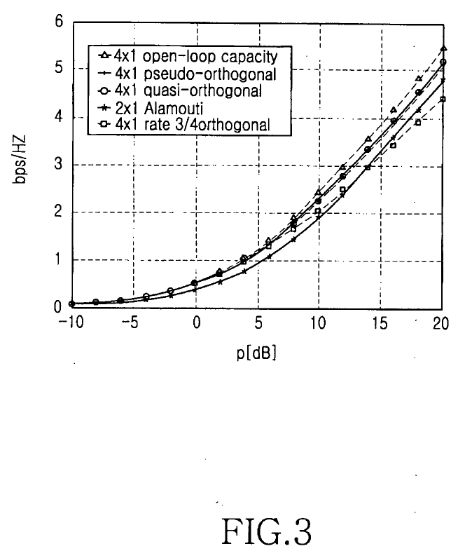

Referring to FIG. 3 a block diagram of the structure of an BS providing time synchronization of an optic repeater in a TDD-OFDM communication system according to one embodiment of the present invention is shown. The BS for timely synchronizing the optic repeater includes a baseband processor 302, a digital Intermediate Frequency (hereinafter referred to as “digital IF processor) 304, a delay controller 306, a Radio Frequency processor (hereinafter referred to as “RF processor”) 308, an optical repeater delay controller 312 and a digital/optic conversion unit (hereinafter referred to as “D/O converter”) 314. For convenience and simplicity, one group including the delay controller 306 and the RF processor 308 is referred to as a “wireless synchronous processor 320”, and another group including the optic repeater delay controller 312 and the D/O converter 314 is referred to as a “wire synchronous processor 330”.

The baseband processor 302 receives information bits to be transmitted to the MS and the optic repeater, encodes the received information bits according to a predetermined coding scheme, and modulates the coded information bits into modulated symbols according to a predetermined modulating scheme, thereby generating modulation symbols. The generated modulation symbols are transformed into baseband signals while passing through an Inverse Fast Fourier Transform (so called “IFFT”) unit (not shown) and the transformed baseband signals are output to the digital IF processor 304. The modulating scheme includes, for example, a Binary Phase Shift Keying (BPSK) scheme, a Quadrature Phase Shift Keying (QPSK) scheme, a 16 Quadrature Amplitude Modulation (16 QAM) scheme, a 64 Quadrature Amplitude Modulation (64QAM) scheme, etc.

The digital IF processor 304 receives signals output from the baseband processor 302 and generates Intermediate Frequency (IF) signals through sampling and filtering of the received signals. The generated IF signals are input to the delay controller 306 and the optic repeater delay controller 312, respectively.

In order to transmit the IF signals over the air, the delay controller 306 of the wireless synchronous processor 320 delays the received IF signals for the maximum delay time, i.e., the fixed delay time before outputting the IF signals to RF processor 308. The RF processor 308 includes a filter, a front end unit, etc. The RF processor 308 RF-processes the IF signals to generate transmissible RF signals and then transmits RF signals over the air via transmit (Tx) antenna.

Meanwhile, the optic repeater delay controller 312 of the wire synchronous processor 330 delays the IF signals by a certain time interval (a variable delay time interval determined based on the system design) and then outputs the delayed IF signals to D/O converter 314. The D/O converter 314 converts the digital IF signals into optical signals and then transmits the optical signals to the optical cable. The D/O converter 314 converts the optical signals to digital signals during the uplink signal receiving interval.

With reference to FIG. 3, the downlink signaling process for transmitting the signals to the MS has been described above. Because the process for receiving the signals in the BS is simply reverse to the downlink signal transmitting process, a detailed description thereof will be omitted. However, in the uplink signal receiving interval, there is no the time delay value which is determined by the optic repeater delay controller 312 during the initial downlink signal transmitting process. Therefore, the BS receives the uplink signals during the next uplink signal receiving interval to determine a delay time value based on the received signal and can obtain an adaptive sync based on the determined delay time value (timing offset) during the downlink/uplink signal transmission intervals.

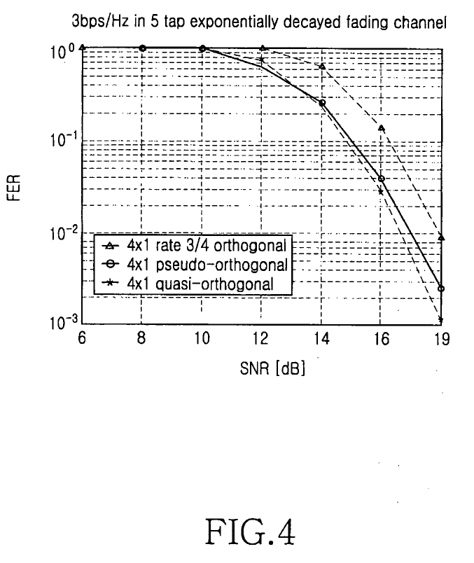

FIG. 4 illustrates a detailed block diagram of the structure of the optic repeater delay controller 312, which includes a delay buffer 402, a switch 404, a timing estimator 406 and a timing controller 408. The delay buffer 402 of the optic repeater delay controller 312 stores and passes the signals received from the digital IF processor 304 to output the passed signals to the D/O converter 314 during the downlink signal transmission interval. In this case, the switch 404 is off during the downlink signal transmission interval so as to prevent the transmitted signals from being fed-back to the timing estimator 406. The variable delay time value delayed in the delay buffer 402 is calculated and determined by the timing estimator 406 and the timing controller 408 during the uplink signal receiving interval.

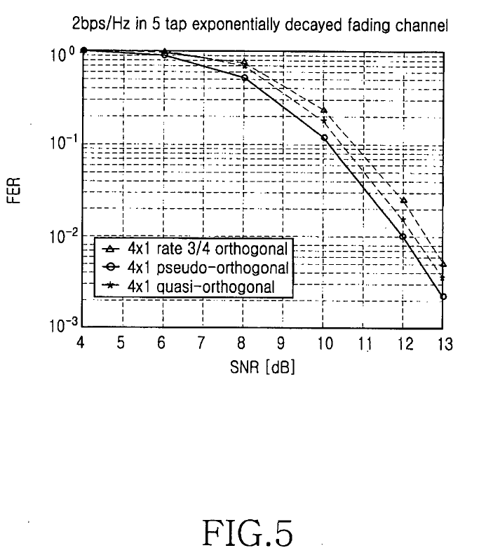

Meanwhile, the D/O converter 314, which has received the optical signals from the MS via the optical cable during the uplink signal receiving interval, converts the received optical signals into the digital signals which then are transferred to the optic repeater delay controller 312. The switch 404 of the optic repeater delay controller 312 is turned on during the uplink signal receiving interval so that the received signals can be fed-back to the timing estimator 406 and the timing controller 408. The timing-estimated time value T₂, which is output from the timing estimator 406, will be described later in detail with reference to FIG. 5. The timing controller 408 receives the time value T₂ as well as a reference time value T₁ generated by a reference clock generator (not shown), and subtracts T₂ from T₁ and adds a time offset initial value Dᵢₙᵢₜᵢₐₗ thereto to determine a time offset value D by which the buffer 402 will perform delaying or advancing. The time offset value D can be expressed as Equation (1) below.
D=Dᵢₙᵢₜᵢₐₗ+(T₁−T₂) (1)

In Equation (1), Dᵢₙᵢₜᵢₐₗ is a delay initial value which is determined based on an expected time offset generated due to the length of the optical cable and the signal process of the optic repeater. With regard to T₁ and T₂, because the lower of the two values is subtracted from the higher value, it should be noted that T₁ and T₂ may be exchanged in their positions. Dᵢₙᵢₜᵢₐₗ is expressed as Equation (2) below.
0<Dᵢₙᵢₜᵢₐₗ<max_fixed _delay_value (2)

The maximum fixed delay value corresponds to a maximum time offset (for example, 40 μs) of the signal transmitted to the antenna of the BS. As mentioned above, because the value Dᵢₙᵢₜᵢₐₗ is set based on the optical cable length as well as an expected time offset caused by a signal process of the optic repeater, the value Dᵢₙᵢₜᵢₐₗ ranges from 0 to the max fixed delay value.

Therefore, the timing controller 408 determines the value D for delaying or advancing the signal in the buffer 402 and controls the buffer 402 based on the determined value D such that a timing offset between the received signals of the optic repeater and the BS antenna can become zero. That is to say, the timing controller 408 acquires a sync between the received signals of the optic repeater and the BS antenna.

Hereinafter, a description will be made of the structure of the timing estimator according to one embodiment of the present invention.

FIG. 5 illustrates a detailed block diagram of the structure of a timing estimator according to one embodiment of the present invention.

Referring to FIG. 5, the timing estimator 406, which operates only during the uplink signal receiving interval, includes a buffer 502 having a sample length of L, a conjugate operator 504, a multiplier 506, an instantaneous signal power measuring unit 508, an average signal power measuring unit 510, a divider 512, and a threshold/peak detector 514. During the uplink signal receiving interval, the switch 404 is turned on and the digital signals are output from the D/O converter 314. The output signals from the D/O converter 314 are input to the multiplier 506 and the buffer 502 with the sample size of L. The buffer 502 delays the input signals as long as the sample length L and then outputs the delayed signals to the conjugate operator 504 and the average signal power measuring unit 510. In this case, the sample length L corresponds to a sample length of the guard interval inserted to the OFDM symbols. Specifically, the sample length L corresponds to the length of the samples inserted to the OFDM symbol by using a cyclic prefix scheme or a cyclic postfix scheme. According to the cyclic prefix scheme, a predetermined number of last samples of the OFDM symbol of a time domain are copied and then inserted into an effective OFDM symbol. According to the cyclic postfix scheme, a predetermined number of first samples of the OFDM symbol of a time domain are copied and then inserted into an effective OFDM symbol.

The conjugate operator 504 performs a conjugate operation of the L sample-delayed signal and then outputs the conjugate-operated signal to the multiplier 506. The multiplier 506 multiplies the conjugate-operated signal by a signal currently received from the D/O converter 314and then outputs the multiplied signal to the instantaneous signal power measuring unit 508. The instantaneous signal power measuring unit 508 measures the instantaneous power of the signal received from the multiplier 506. This relationship can be expressed by Equation (3) below.

$${C}_{n} = {\vert {\sum }_{k = 0}^{L - 1} {r}_{n} + {}_{k}^{}{r}{}_{n + k + L}^{*} \vert}^{2} \qquad ( 3 )$$

In Equation (3), Cₙ denotes the n^{th} auto-correlation output value of a signal received by the BS, and rₙ₊ₖ denotes the signal received at the (n+k)^{th} time by the BS via the optic repeater.

Meanwhile, the average signal power measured by the average signal power measuring unit 510 can be expressed as Equation (4) below.

$${P}_{n} = {\vert {\sum }_{k = 0}^{L - 1} {r}_{n + k + L} \vert}^{2} \qquad ( 4 )$$

In Equation (4), Pₙ denotes the average power of the L sample signal received by the BS via the optic repeater, and the rₙ₊ₖ denotes the signal received at the (n+k)^{th} time by the BS via the optic repeater. Pₙ is used for maintaining the amplitude of a signal input to the threshold/peak detector 514 within a range from 0 to 1.

Accordingly, for values Cₙ and Pₙ obtained through calculations according to Equations (3) and (4), the divider 512 performs a calculation of

$$\frac{{C}_{n}}{{P}_{n}} ,$$

the result of which is then output to the threshold/peak detector 514. The threshold/peak detector 514 detects a timing-offset-estimated signal T₂ based on the received resultant value

$$\frac{{C}_{n}}{{P}_{n}}$$

and outputs the detected signal T₂ to the timing controller 408. In other words, when the variably-settable-threshold value is determined and the value

$$\frac{{C}_{n}}{{P}_{n}}$$

is higher than the determined threshold value, the peak value can be determined. Also, the delay time can estimated based on the offset value determined depending on the threshold value. Then, the estimated delay time is determined as T₂.

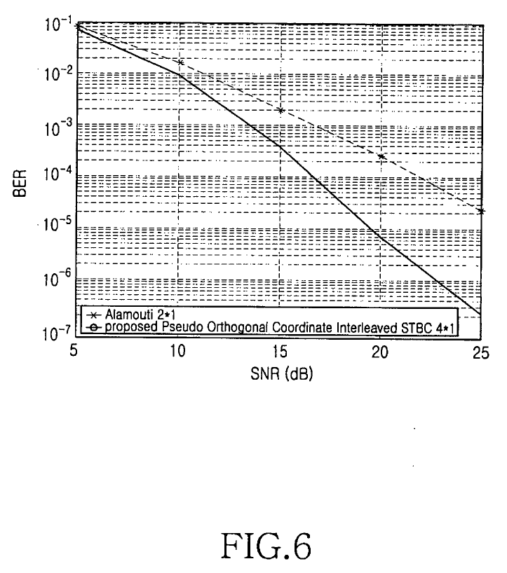

FIGS. 6A and 6B show a flow chart of an operation process of the BS for BS sync control in order to synchronize the optic repeater in a TDD-OFDM system according to one embodiment of the present invention.

Referring to FIG. 6, in step 602, when it is necessary to transmit data to the MS, the BS encodes the data in accordance with a predetermined encoding scheme which may be, for example, a convoluted coding scheme or a turbo coding scheme having a predetermined coding rate. The coded bits are modulated into symbols by a predetermined modulation scheme. Thereafter, the modulated symbols undergo a serial-to-parallel conversion and an Inverse Fast Fourier Transform (IFFT), thereby generating baseband and IF band signals. Then, the process goes to steps 604 and 618. The modulation scheme may be, for example, Binary Phase Shift Keying (BPSK) scheme, Quadrature Phase Shift Keying (QPSK) scheme, 16 Quadrature Amplitude Modulation (QAM) scheme, or 64 Quadrature Amplitude Modulation (QAM) scheme.

Steps 604 to 614 correspond to a procedure in which the BS delays the radio signal received from the MS via the antenna by a fixed time interval in order to synchronize the received signal with a signal received through the optical cable, and steps 618 to 628 corresponds to a procedure in which the BS delays the optical signal received through the optical cable by a variable time interval in order to synchronize the optical signal with the radio signal.

First, in step 604, the delay controller 306 of the BS delays the signals as long as the predetermined maximum delay time and then proceeds to step 606 wherein the RF processor 308 of the BS transmits the above signals to the MS via the antenna. Next, in step 608, the BS determines if the downlink signal transmission interval has terminated and the uplink signal receiving interval has started in a time division frame interval. If the frame interval is the uplink signal receiving interval, then the process goes to step 610. If the frame interval is still the downlink frame interval, then the process returns to step 602 to be repeated.

In step 610, during the uplink frame interval, the BS receives the uplink signals from the MS via antenna, then the process goes to step 612 wherein the BS converts the radio frequency band signals received via antenna into digital IF band signals. Next, in step 614, the delay controller 306 delays the signals received via the antenna by the maximum delay time in order to synchronize the received signals with the signals received from the optical cable and then proceeds to step 630.

Steps 618 to 628 corresponds to an operation performed by the wire synchronous processor 330. In step 618, the optic repeater delay controller 312 delays the signals to be transmitted to the MS by a variable time interval corresponding to the variable time delay value calculated by the predetermined operation described with reference to FIG. 5. Next, in step 620, the BS converts the variable-delayed signals into optical signals which are then transmitted to the MS during the downlink frame time interval. Next, in step 622, the BS determines if the downlink frame time interval has terminated and the uplink frame time interval has started. If the uplink frame time section has started, the process goes to step 624. In contrast, if the downlink frame interval still continues, then the process returns to step 602 to be repeated. In step 624, the D/O converter 314 of the BS receives the optical signals from the MS through the optical cable. In step 626, the D/O converter 314 of the BS converts the received optical signals to digital signals. In step 628, the optic repeater delay controller 312 of the BS delays the received signals by a variable time interval corresponding to the variable delay time value calculated in accordance with a predetermined operation.

Next, in step 630, the digital IF processor 304 of the BS combines signals processed in the wireless synchronous processor 320 with signals processed in the wire synchronous processor 330, and then proceeds to step 632 wherein the BS demodulates the signals by a predetermined demodulation scheme. In step 634, the BS determines if the frame time section is the downlink frame time interval or the uplink frame time interval. As a result of the determination, if the downlink frame time section has started, the process goes to step 636 wherein the process returns to step 602, and the BS performs the procedures after step 602. If the uplink frame time interval still continues, the process goes to step 638, in which the process returns to steps 610 and 624, where the BS performs the procedures after step 610 or step 624, respectively.

Although the above description has discussed TDD-OFDM and the TDD-OFDMA as examples, the present invention can be applied to any communication system which uses an optic repeater as a link. It should be noted that the present invention solves the problem of the asynchronization of the signals transmitted and received through the optical cable.

As mentioned above, according to the present invention, in a communication system using a time division orthogonal frequency division multiplexing scheme together with an optic repeater, it is possible to obtain synchronization between the signals transmitted from and received by the BS and the signals transmitted from and received by the optic repeater. Therefore, the present invention has an advantage in that the present invention can prevent deterioration of signal performance due to asynchronization. Further, the present invention has an advantage in that the present invention can achieve adaptive synchronization, so that it is possible to solve the time delay problem which may occur in proportion to the length of the optical cable necessary for the optic repeater.

While the invention has been shown and described with reference to certain preferred embodiments thereof, various changes in forms and details may be made within the scope of the present invention. Accordingly, the scope of the present invention should not be limited to the embodiments described in the specification but to the appended claims or its equivalents.

What is claimed is:

1. A method for synchronizing a first signal and a second signal by a base station in a communication system including a mobile station, the base station and an optic repeater, the base station and the optic repeater being connected through an optical cable, the first signal being transmitted between the base station and the mobile station, the second signal being transmitted between the base station and the mobile station via the optic repeater, the method comprising the steps of:
transmitting the first signal after delaying the first signal by a predetermined delay time; and
synchronizing the second signal with the first signal by delaying the second signal by an adaptive time delay determined according to a predetermined scheme.

2. The method as claimed in claim 1, wherein the adaptive time delay is determined by:
D=Dᵢₙᵢₜᵢₐₗ+(T₁−T₂),
wherein D is the adaptive delay time, Dᵢₙᵢₜᵢₐₗ is a delay initial time previously determined, T₁ is a reference signal time previously recognized in the base station, and T₂ is a timing-estimated time.

3. The method as claimed in claim 2, wherein Dᵢₙᵢₜᵢₐₗ has a value ranging from 0 to the predetermined delay time.

4. The method as claimed in claim 2, wherein T₂ is determined by a ratio of an instantaneous signal power to an average signal power.

5. A base station apparatus for synchronizing a first signal and a second signal in a communication system including a mobile station, a base station and an optic repeater, the base station and the optic repeater being connected via an optical cable, the first signal being transmitted between the base station and the mobile station, the second signal being transmitted between the base station and the mobile station through the optic repeater, the base station apparatus comprising:
a delay controller for transmitting the first signal after delaying the first signal by a predetermined delay time; and
an optic repeater delay controller for synchronizing the second signal with the first signal by delaying the second signal by an adaptive delay time determined according to a predetermined scheme.

6. The apparatus as claimed in claim 5, wherein the optic repeater delay controller comprises:
a timing estimator for receiving uplink signals, obtaining a ratio of an instantaneous signal power to an average signal power based on the received uplink signals and determining a timing-estimated signal based on the obtained ratio;
a timing controller for calculating a time difference between the signal estimated in the timing estimator and a reference signal and determining a delay time value based on the calculated time difference; and
a delay buffer for delaying the signal for the determined delay time value by control of the timing controller.

7. The apparatus as claimed in claim 6, further comprising a switch which is turned off during a downlink signal transmission interval and turned on during an uplink signal receiving interval.

8. The apparatus as claimed in claim 6, wherein the timing estimator comprises:
an instantaneous signal power measuring unit for measuring the instantaneous signal power of the uplink signal;
an average signal power measuring unit for measuring an average signal power of a signal which has been delayed for a certain time; and
a threshold/peak detector for receiving the ratio of the instantaneous signal power to the average signal power and determining the timing-estimated signal based on the received ratio.

9. The apparatus as claimed in claim 6, wherein the delay time value determined in the timing controller is determined by:
D=Dᵢₙᵢₜᵢₐₗ+(T₁−T₂),
wherein D is the delay time, Dᵢₙᵢₜᵢₐₗ is a delay initial time previously determined based on optical cable length and a signal processing time of the optic repeater, T₁ is a reference signal time previously recognized in the base station, and T₂ is a timing-estimated time corresponding to the timing-estimated signal.

10. The method as claimed in claim 9, wherein Dᵢₙᵢₜᵢₐₗ has a value ranging from 0 to the predetermined delay time.

11. A method for synchronizing a first signal and a second signal by a base station in communication system including a mobile station, the base station and an optic repeater, the base station and the optic repeater being connected via an optical cable, the first signal being transmitted from a modem of the base station to an antenna of the base station, the second signal being transmitted from the base station modem to an antenna of the optic repeater, the method comprising the steps of:
transmitting the first signal after delaying or advancing the first signal by a predetermined delay or advance time; and
synchronizing the second signal with the first signal by delaying or advancing the second signal by an adaptive delay time or an adaptive advance time according to a predetermined scheme.

12. The method as claimed in claim 11, wherein the adaptive time delay is determined by:
D=Dᵢₙᵢₜᵢₐₗ+(T₁−T₂),
wherein D is the adaptive delay time, Dᵢₙᵢₜᵢₐₗ is a delay initial time previously determined, T₁ is a reference signal time previously recognized in the base station, and T₂ is a timing-estimated time.

13. The method as claimed in claim 12, wherein Dᵢₙᵢₜᵢₐₗ has a value ranging from 0 to the predetermined delay time.
